(19) United States
(12) Patent Application Publication
(10) Pub. No.: US 2011/0062251 A1
(43) Pub. Date: Mar. 17, 2011

(54) QUARTER TURN SIDE SEAL ASSEMBLY

(76) Inventors: Christopher J. Pellin, Burnsville, MN (US); Joseph E. Tix, Hastings, MN (US)

(21) Appl. No.: 12/992,458

(22) PCT Filed: May 14, 2009
(86) PCT No.: PCT/US09/43895

§ 371 Date: Nov. 12, 2010

Related U.S. Application Data
(60) Provisional application No. 61/053,256, filed on May 15, 2008.

(51) Int. Cl. B05B 15/00

(52) U.S. Cl. 239/104

(57) ABSTRACT

The side seal assembly consists of three main components: a hardened and precision ground side seal 12, a spring 14 and a housing 16 in which the side seal 12 and spring 14 are assembled. The side seal contains two tabs 22 that fit through a slot feature 24 in the housing. The tabs 22 on the side seal 12 slide through the housing slot 24 into a relief area 26 that allows the side seal 12 to turn 90 degrees and fall into a shallow pocket 28 that keeps the side seal 12 retained.

This application claims the benefit of U.S. Application Ser. No. 61/053,256, filed May 15, 2008, the contents of which are hereby incorporated by reference.

### TECHNICAL FIELD

### Background Art

Spray guns for application of fast setting materials such as polyurethanes and polyureas are well known. Because these materials set up so fast, it is important that the gun or applicator be easily disassembled with a minimum of tools for cleaning.

### DISCLOSURE OF THE INVENTION

The side seal assembly consists of three main components: a hardened and precision ground side seal, a spring and a housing in which the side seal and spring are assembled into (see FIG. 1). The side seal is considered to be a wear item that the operator may have to remove and reassemble. The side seal contains two tabs that fit through a slot feature in the housing. The tabs on the side seal slide through the housing slot into a relief area that allows the side seal to turn 90 degrees and fall into a shallow pocket that keeps the side seal retained. Spring force ensures that the side seal cannot easily disengage from the pocket that the tabs are resting in.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is an exploded view of the side seal assembly of the instant invention.

FIGS. 2, 3 and 4 are views showing the side seal at different points during assembly with FIG. 4 being the final assembled location of the side seal in the housing.

FIG. 5 is an exploded view of a spray gun utilizing the side seal assemblies of the instant invention.

### BEST MODE FOR CARRYING OUT THE INVENTION

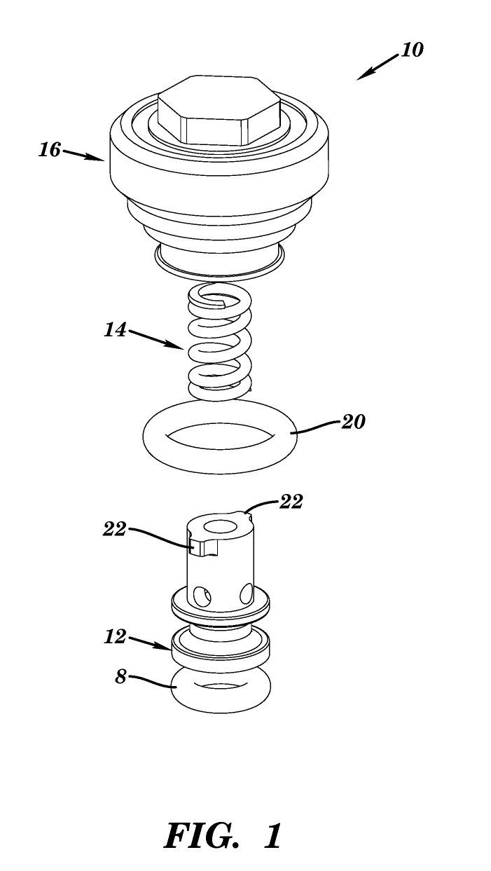

The side seal assembly, generally designated 10, consists of three main components: a hardened and precision ground side seal 12, a spring 14 and a housing 16 in which the side seal 12 and spring 14 are assembled (see FIG. 1). All three parts are constructed of stainless steel in the preferred embodiment. The side seal 12 is considered to be a wear item that the operator may have to remove and reassemble.

The side seal contains two tabs 22 that fit through a slot feature 24 in the housing. The tabs 22 on the side seal 12 slide through the housing slot 24 into a relief area 26 that allows the side seal 12 to turn 90 degrees and fall into a shallow pocket 28 that keeps the side seal 12 retained. Spring 14 force ensures that the side seal 12 cannot easily disengage from the pocket 28 that the tabs 22 are resting in.

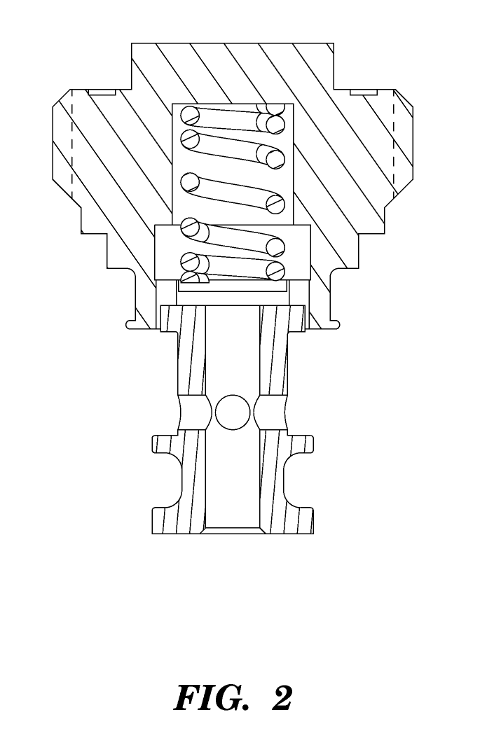

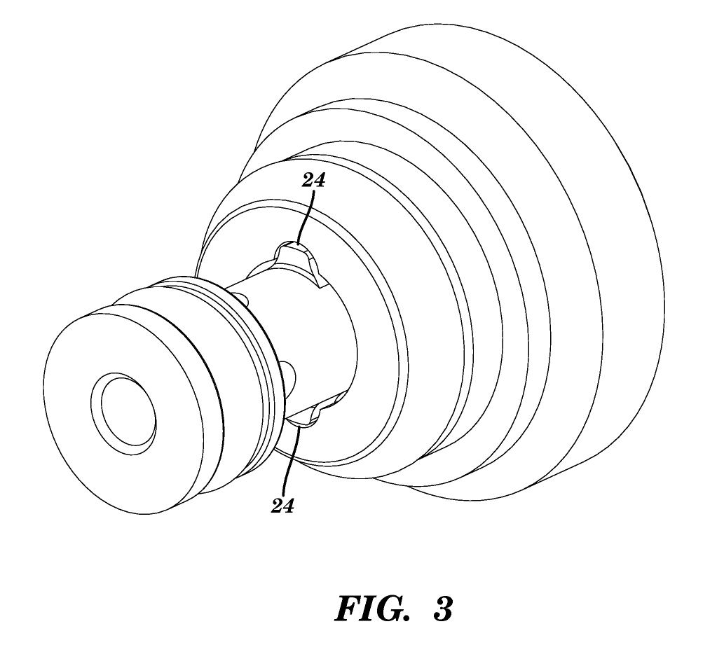

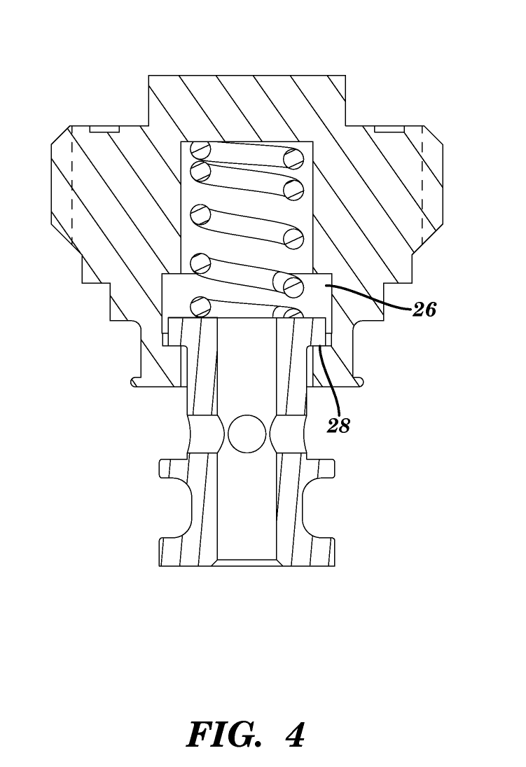

FIGS. 2, 3, and 4 show the side seal 12 at different points during assembly with FIG. 4 being the final assembled location of the side seal 12 in the housing 16. O-rings 18 and 20 are located on the exterior of side seal 12 and housing 16 respectively for sealing.

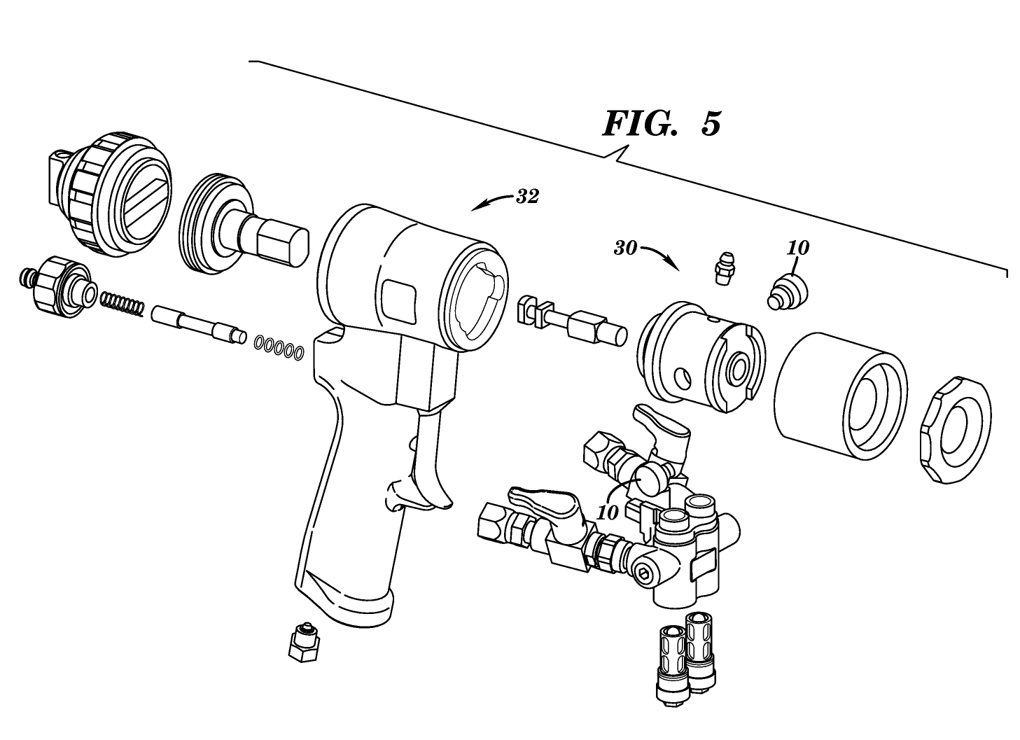

FIG. 5 shows the side seal assemblies 10 exploded away from the fluid housing 30 of spray gun 32 into which they are threadedly installed.

It is contemplated that various changes and modifications may be made to the side seal assembly without departing from the spirit and scope of the invention as defined by the following claims.

1. A side seal assembly for a fast set plural component spray gun having a housing, said assembly comprising:
at least one slot in said housing;
a hardened side seal;
a spring; and
a housing in which said side seal and spring are assembled, side seal comprising at least two tabs that fit through said slot in said housing.

2. The side seal assembly of claim 1 wherein said housing slot comprises a relief area and said tabs on said side seal slide through said housing slot into said relief area allowing said side seal to turn 90 degrees and fall into a shallow pocket 28 that keeps said side seal retained.
